(19) United States
(12) Patent Application Publication
(10) Pub. No.: US 2008/0246953 A1
(43) Pub. Date: Oct. 9, 2008

(54) TRANSMISSION CONCENTRATION DEVICE CAPABLE OF REDUCING ENVIRONMENTAL TEMPERATURE EFFECT

(75) Inventors: YUNG-LIEH CHIEN, Chupei (TW); CHUN-CHIN TUNG, Chupei (TW)

Correspondence Address: G. LINK CO., LTD., 3550 BELL ROAD, MINOOKA, IL, 60447, US

(73) Assignee: SYSPOTEK CORPORATION, CHUPEI (TW)

(21) Appl. No.: 12/059,428

(22) Filed: Mar. 31, 2008

(30) Foreign Application Priority Data
Apr. 3, 2007 (TW) 096111792

(51) Int. Cl. G01N 21/00

(52) U.S. Cl. 356/72

(57) ABSTRACT

A transmission concentration device capable of reducing environmental temperature effect comprises mainly a concentration detector arranged in the fluid communication space of a fluid circulating apparatus in a fuel cell system where the fluid temperature in the concentration detector and the fuel cell is equal to help minimize measurement error brought about by the effect of environmental temperature.

### FIELD OF THE INVENTION

The present invention relates to a transmission concentration device capable of reducing environmental temperature effect, particularly a device for determining fluid concentration through change of optical properties.

### BACKGROUND OF THE INVENTION

Conventional fluid measuring devices perform measurement based on the physical characteristics of fluid, such as concentration, density or quantity. General fluid measuring devices are sizable and complex in structure, and hence are more costly. However there is increasingly market demand for small-size and low-cost products. Take the example of fuel cell system, its applications in portable electronic devices are picking up. In a fuel cell system that uses hydrogen-rich fluid (e.g. methanol) and oxygen fluid to undergo electrochemical reaction and output power, it is necessary for users to know when to replenish the fuel when fluid concentration or level becomes low. Thus it is necessary to detect the fluid fuel level and volume in the fuel container. Such detection work is typically achieved through expensive metering sensor, which is rather uneconomical when used extensively in portable electrical products.

In addition, in the electrochemical reaction of a fuel cell system, variations of fuel temperature along with the progression of the electrochemical reaction might result in measurement errors. Thus it becomes necessary to compensate the fluid temperature in order to obtain accurate measurement of the physical characteristics of fluid.

In light of the drawbacks of conventional fluid measuring devices, the inventor aims to develop a fluid concentration detector that meets the demands.

### SUMMARY OF THE INVENTION

The primary object of the invention is to provide a transmission concentration device that brings the fluid temperature in the concentration detector and the fuel cell to equal state to preclude measurement error brought about by temperature difference.

The objects, features and effects of the invention are described in detail below with embodiments in reference to the accompanying drawings.

### BRIEF DESCRIPTION OF THE DRAWINGS

FIG. 1 is a diagram showing the relations of major components of the invention;

FIG. 2 is a side view of partial components in a first embodiment of the invention;

FIG. 3 is a graph illustrating the relationships of concentration-current-temperature according to the invention;

FIG. 4 is a side view of partial components in a second embodiment of the invention;

FIG. 5 is a side view of partial components in a third embodiment of the invention; and

FIG. 6 is a side view of partial components in a fourth embodiment of the invention.

### DETAILED DESCRIPTION OF THE INVENTION

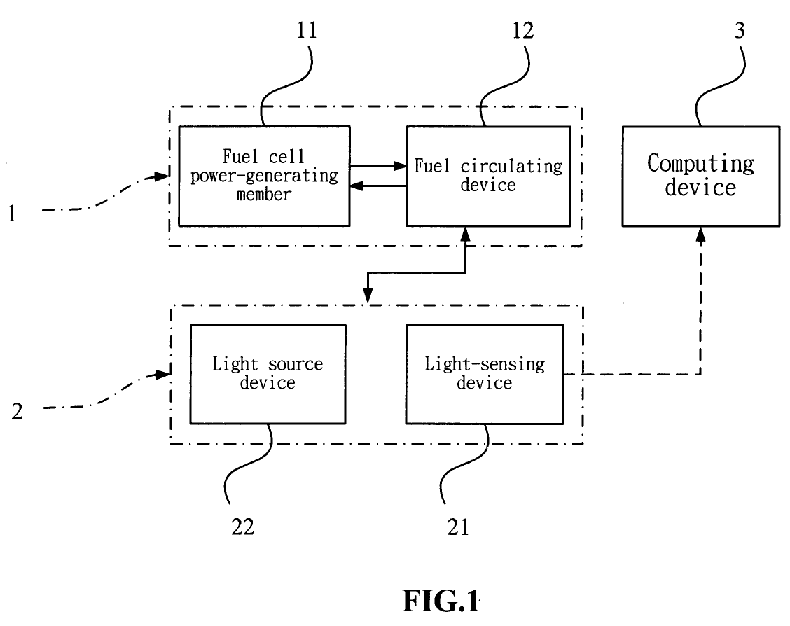

Referring to FIG. 1 which shows the relations of major components of the invention, the present invention provides a concentration detector (2) used in a fuel cell system (1). The concentration detector (2) is correspondingly disposed in the interior of the fuel cell system (1) for storing or transporting fluid to detect the concentration of fluid therein and output an electrical signal corresponding to the fluid concentration to a computing device (3). The computing device (3) determines the fluid concentration corresponding to the electrical signal.

The fuel cell system (1) comprises a fuel cell power generating member (11) and a fluid circulating apparatus (12). The fuel cell power generating member (11) contains a catalytic substance which catalyzes the electrochemical reaction of hydrogen-rich fluid and oxygen fluid, and an energy converter that converts chemical energy into electrical energy for output. The fluid circulating apparatus (12) is for storing and transporting the fluid needed for the electrochemical reaction of the fuel cell system (1) and residual solution after the reaction.

The concentration detector (2) comprises a light sensing device (21) and a light source device (22). The light sensing device (21) converts optical signal into electrical signal such that under illumination, the light sensor could output a corresponding current value or another electrical signal based on the dose of light received. The light source device (22) supplies source of light, which is infrared light, visible light or single-wavelength light.

The computing device (3) has logic computing means to process electrical signals output by the concentration detector (2) and computes corresponding fuel concentration. The computing device (3) can be achieved through circuit means and is able to capture the current value output by respective light sensor corresponding to the state of illumination, and based on which output an electrical signal carrying the current value information. The interface for signal output by the computing device (3) adopts SMBus interface or 12C interface.

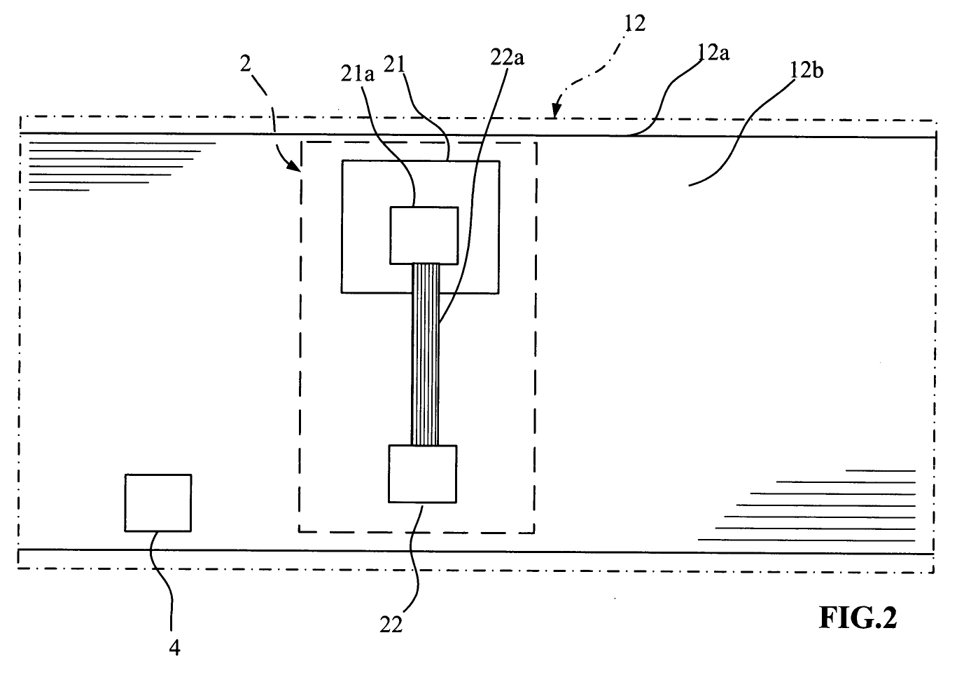

FIG. 2 is a side view of partial components in a first embodiment of the invention. As shown in FIG. 1 and FIG. 2, the fluid circulating apparatus (12) in the fuel cell system (1) contains a fluid communication space (12a) through which the fluid (12b) in fluid circulating apparatus (12) can be transported or stored. The fluid (12b) stored in fluid circulating apparatus (12) is the mixture of pure water and other compounds. Thus the concentration of the fluid (12b) is determined by the ratio of pure water in the fluid. Moreover, the light sensing device (21) has at least a light sensor (21a) which is a photosensitive element capable of converting optical signal into electrical signal such that under illumination, the light sensor could output a corresponding current value or another electrical signal based on the dose of light received. The light sensing device (21) and the light source device (22) are arranged oppositely at two sides of the fluid communication space (12a) of fluid circulating apparatus (12) such that the light beam (22a) emitted by the light source device (22) can reach the light sensor (21a) of light sensing device (21) through fluid circulating apparatus (12).

Based on the transmission concentration device capable of reducing the environmental temperature effect according to the invention, when the light source device (22) in the concentration detector (2) produces a light beam (22a) which is incident on the fluid communication space (12a) of fluid circulating apparatus (12) and penetrates the fluid (12b), part of the light beam (22a) energy is absorbed by the fluid (12b) in the fluid communication space (12a), while the remaining energy is incident on the light sensor (21a) of the light sensing device (21), which would convert the optical signal received into a corresponding electrical signal. Finally the computing device (3) computes based on the electrical signal to obtain the concentration of fluid (12b) in the fluid communication space (12a).

The part of the fluid communication space (12a) in the fluid circulating apparatus (12) corresponding to the light beam (22a) emitted by the light source device (22) and another part of fluid circulating apparatus (12) where the light sensor (21a) receives the light beam (22a) are light transmittable, while the remaining parts of the fluid circulating apparatus (12) are non-light transmittable, hence preventing external light from interfering with the optical signals received by the light sensor (21a). In addition, said part of the fluid communication space (12a) in the fluid circulating apparatus (12) is a space in fluid circulating apparatus (12) for transmitting or storing fluid (12b). In fact, the fluid communication space (12a) contains a flow channel for transporting the fluid (12b) or a fluid tank for storing the fluid (12b).

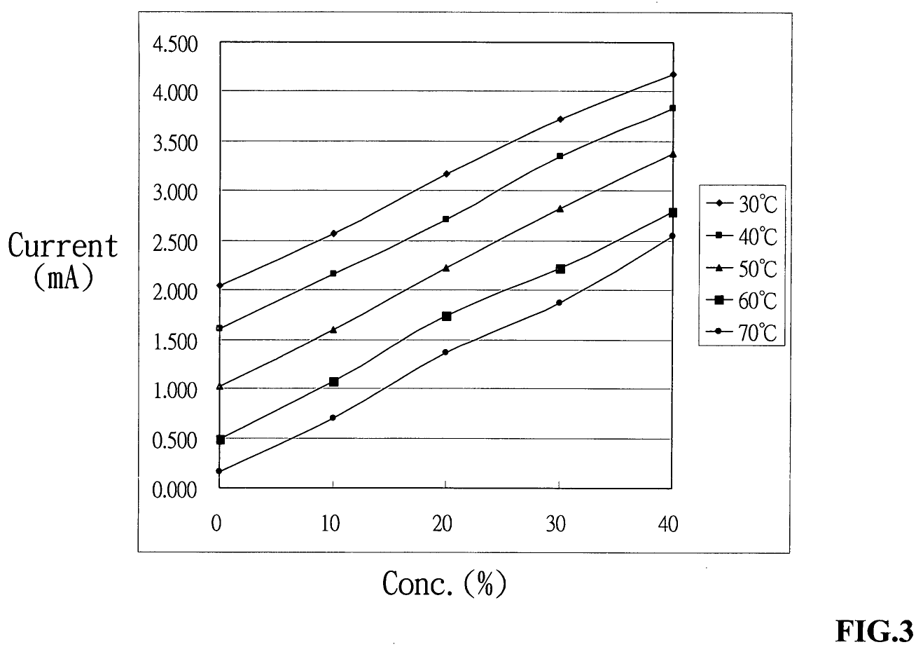

Given that the concentration detector (2) is disposed in the fluid communication space (12a) of the fluid circulating apparatus (12), the overall temperature of the concentration detector (2) will be influenced by the fluid temperature. To avoid unnecessary measurement error resulting from the influence of environmental temperature, the fuel cell system (1) further comprises a temperature sensing unit (4) correspondingly disposed in a part of the fluid communicating space (12a) in the fluid circulating apparatus (12) such that the temperature sensing unit (4) can measure the temperature of fluid (12b) in the fluid communication space (12a). FIG. 3 is a graph illustrating the relationships of concentration-current-temperature according to the invention. When the light sensor (21a) receives light signal from the light source device (22), it would output a current signal corresponding to the intensity of light received, while part of the light beam (22a) provided by the light source device (22) would be absorbed by the passing fluid (12b) or would penetrate the fluid (12b). Factors influencing the absorption of partial energy of light beam (22a) by the fluid (12b) or the transmittance of light beam (22a) include the concentration and the temperature of fluid (12b). Thus it is necessary to first establish a concentration-current-temperature relationship using the concentration detector (2) under specific temperature and corresponding fluid concentration as basis for temperature compensation during concentration measurement. The aforesaid concentration-current-temperature relationship can be embedded in the computing device (3) in the form of a reference table or a functional equation for determining the concentration of fluid (12b) based on the transmittance and temperature of fluid (12b) fed back by the concentration detector (2) and the temperature sensing unit (4). In the implementation of the reference table, the computing device (3) can obtain other data on concentration-current-temperature through extrapolation or interpolation based on the existing concentration-current-temperature relationship.

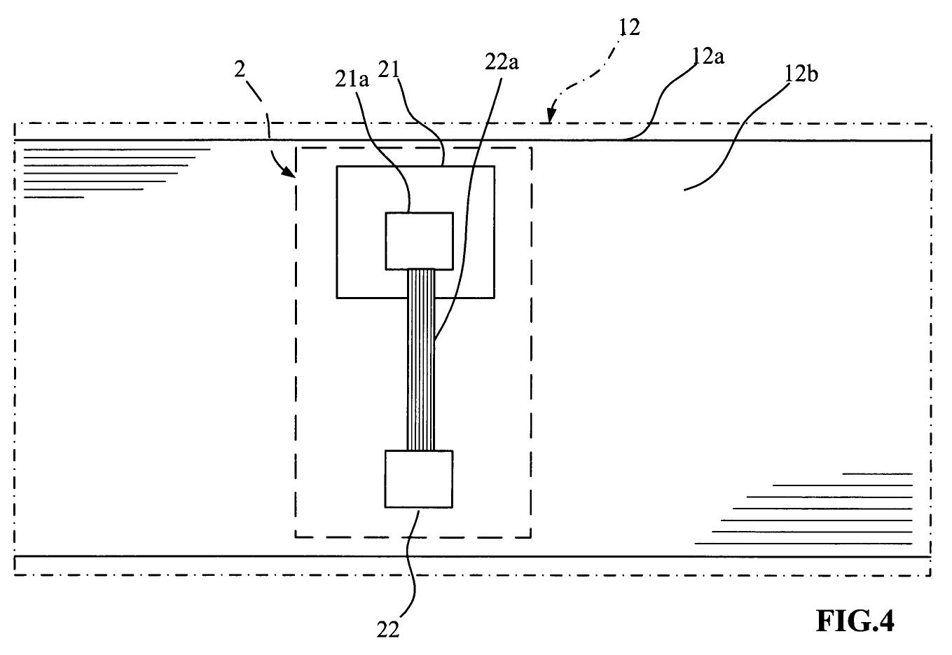

FIG. 4 is a side view of partial components in a second embodiment of the invention. The difference between this embodiment and the aforementioned embodiment is that the function of the temperature sending unit (4) is replaced by the light source device (22). The light source device (22) could be a semiconductor light emitting element. When DC power of specific voltage is input into the light source device (22), the luminance or intensity of light beam (22a) emitted by the light source device (22) corresponds to the DC power of specific voltage input. Given that the light source device (22) would also produce different voltage drop corresponding to the environmental temperature, such characteristic of the light source device (22) could be utilized to detect environmental temperature in place of the temperature sensing unit (4) provided in the previous embodiment. In a specific example, a DC power of specific voltage is provided for the light source device (22), and voltage drop of the light source device (22) versus temperature is established by measuring the voltage drop after the power passes through the light source device (22) under varying temperature. Based on such relationship, the concentration device of the invention can obtain information on the environmental temperature surrounding the light source device (22) and its luminance by measuring the voltage drop of light source device (22), and based on such information, compensate the electrical signal fed back by the light sensing device (21). As such, with the luminance of the light source device (22) known, electrical signal corresponding to the concentration of fluid (12b) can be obtained based on the electrical signal free of the effect of environmental temperature as fed back by the light sensing device (21).

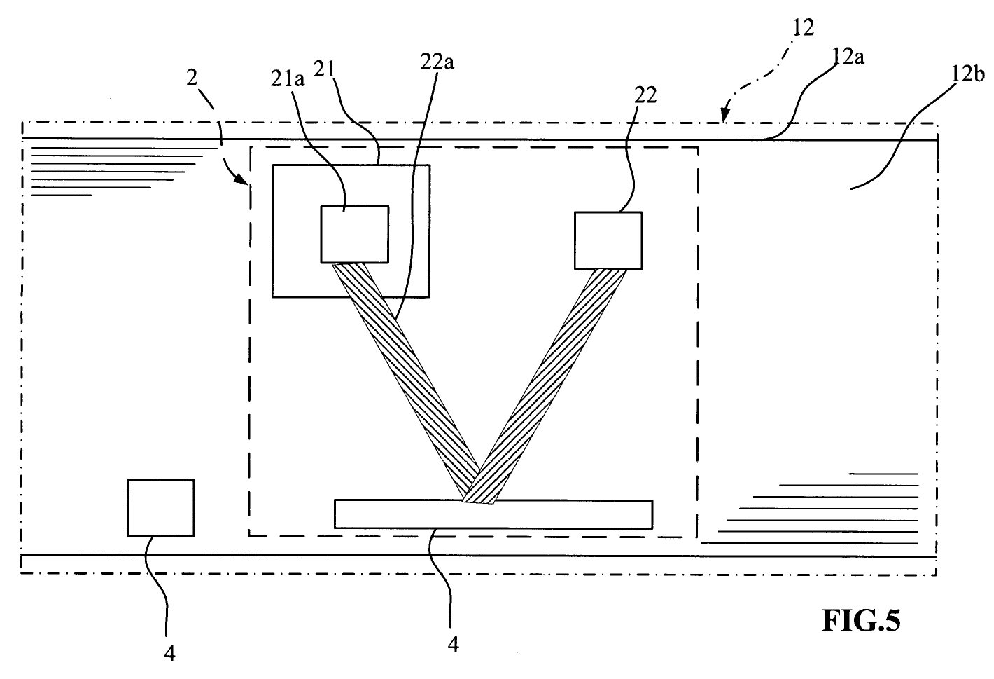

FIG. 5 is a side view of partial components in a third embodiment of the invention. As shown, the fluid circulating apparatus (12) in the fuel cell system (1) contains a fluid communication space (12a) through which the fluid (12b) in fluid circulating apparatus (12) can be transported or stored. The fluid (12b) stored in fluid circulating apparatus (12) is the mixture of pure water and other compounds. Thus the concentration of the fluid (12b) is determined by the ratio of pure water in the fluid. Moreover, the light sensing device (21) has at least a light sensor (21a) which is a photosensitive element capable of converting optical signal into electrical signal such that under illumination, the light sensor could output a corresponding current value or another electrical signal based on the dose of light received. The light sensing device (21) and the light source device (22) are arranged oppositely inside the fluid communication space (12a) of fluid circulating apparatus (12) such that when the light source device (22) projects the light beam (22a), the light beam (22a) is first incident on a reflective element (23), which then refracts the light beam (22a) to the light sensing device (21). As such, the light beam (22a) emitted by the light source device (22) can reach the light sensor (21a) of light sensing device (21) through the fluid circulating apparatus (12).

Based on the transmission concentration device capable of reducing the environmental temperature effect according to the invention, when the light source device (22) in the concentration detector (2) produces a light beam (22a) which is incident on the fluid communication space (12a) of fluid circulating apparatus (12) and penetrates the fluid (12b), part of the light beam (22a) energy is absorbed by the fluid (12b) in the fluid communication space (12a), while the remaining light beam (22a) energy would refract via the reflective element (23) to be incident on the light sensor (21a) of light sensing device (21). The light sensor (21a) would convert the optical signal received into a corresponding electrical signal. Finally the computing device (3) computes based on the electrical signal to obtain the concentration of fluid (12b) in the fluid communication space (12a).

The part of the fluid communication space (12a) in the fluid circulating apparatus (12) corresponding to the light beam (22a) emitted by the light source device (22) and another part of fluid circulating apparatus (12) where the light sensor (21a) receives the light beam (22a) are light transmittable, while the remaining parts of the fluid circulating apparatus (12) are non-light transmittable, hence preventing external light from interfering with the optical signals received by the light sensor (21a). In addition, said part of the fluid communication space (12a) in the fluid circulating apparatus (12) is a space in fluid circulating apparatus (12) for transmitting or storing fluid (12b). In fact, the fluid communication space (12a) contains a flow channel for transporting the fluid (12b) or a fluid tank for storing the fluid (12b).

Given that the concentration detector (2) is disposed in the fluid communication space (12a) of the fluid circulating apparatus (12), the overall temperature of the concentration detector (2) will be influenced by the fluid (12b) temperature. To avoid unnecessary measurement error resulting from the influence of environmental temperature, the fuel cell system (1) further comprises a temperature sensing unit (4) correspondingly disposed in a part of the fluid communicating space (12a) in the fluid circulating apparatus (12) such that the temperature sensing unit (4) can measure the temperature of fluid (12b) in the fluid communication space (12a). Again referring to the concentration-current-temperature relationship graph in FIG. 3, it is obtained by the concentration detector (2) under specific temperature and corresponding to specific fluid concentrations. The aforesaid concentration-current-temperature relationship can be embedded in the computing device (3) in the form of a reference table or a functional equation for determining the concentration of fluid (12b) based on the transmittance and temperature of fluid (12b) fed back by the concentration detector (2) and the temperature sensing unit (4). In the implementation of the reference table, the computing device (3) can obtain other data on concentration-current-temperature through extrapolation or interpolation based on the existing concentration-current-temperature relationship.

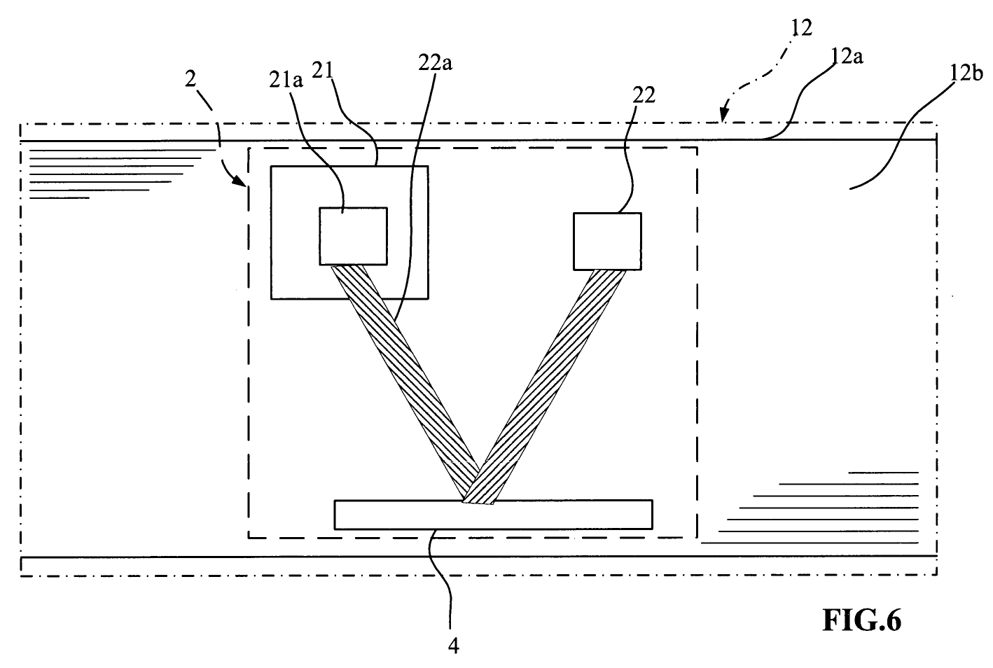

FIG. 6 is a side view of partial components in a fourth embodiment of the invention. The difference between this embodiment and the aforementioned embodiment is that the function of the temperature sending unit (4) is replaced by the light source device (22). The light source device (22) could be a semiconductor light emitting element. When DC power of specific voltage is input into the light source device (22), the luminance of light beam (22a) emitted by the light source device (22) corresponds to the DC power of specific voltage input. Given that the light source device (22) would also produce different voltage drop corresponding to the environmental temperature, such characteristic of the light source device (22) could be utilized to detect environmental temperature in place of the temperature sensing unit (4) provided in the previous embodiment. In a specific example, a DC power of specific voltage is provided for the light source device (22), and voltage drop of the light source device (22) versus temperature is established by measuring the voltage drop after the power passes through the light source device (22) under varying temperature. Based on such relationship, the concentration device of the invention can obtain information on the environmental temperature surrounding the light source device (22) and its luminance by measuring the voltage drop of light source device (22), and based on such information, compensate the electrical signal fed back by the light sensing device (21). As such, with the luminance of the light source device (22) known, electrical signal corresponding to the concentration of fluid (12b) can be obtained based on the electrical signal free of the effect of environmental temperature as fed back by the light sensing device (21).

To sum up, the present invention provides a transmission concentration device capable of reducing the environmental temperature effect characterized in which a concentration detector is placed in the fluid communication space to reduce measurement error brought about by the effect of environmental temperature. The invention possesses inventive step and meets the essential criteria for patent.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A transmission concentration device capable of reducing environmental temperature effect used primarily for detecting the concentration of fluid in a fluid circulating apparatus, comprising:
a light source device containing a light emitting element, the light emitting element outputting an optical signal;
a light-sensing device comprising at least a light sensor, the light sensor receiving the optical signal from the light source device and outputting an electrical signal corresponding to the intensity of the optical signal;
a temperature sensing unit arranged corresponding to the fluid circulating apparatus for detecting the temperature of fluid in the fluid circulating apparatus; and
a computing device;
wherein the light sensor of the light sensing device and the light source device are arranged oppositely at two sides of a partial space of the fluid circulating apparatus such that the light beam emitted by the light source device can be projected on the light sensor of light sensing device through the fluid in the fluid circulating apparatus, and the light sensor then outputs an electrical signal corresponding to the optical signal and the fluid concentration to the computing device; the computing device comprising a concentration-current-temperature relationship determination means to compute the fluid concentration in the fluid communication space of the fluid circulating apparatus based on the electrical signal output by the light sensor of light sending device and the electrical signal output by the temperature sensing unit.

2. The transmission concentration device capable of reducing environmental temperature effect according to claim 1, wherein the light sensor outputs a current value, the current value corresponding to the transmittance of light beam produced by the light source device and passing through the fluid in a partial space of the fluid circulating apparatus.

3. The transmission concentration device capable of reducing environmental temperature effect according to claim 2, wherein the concentration-current-temperature relationship is embedded in the computing device in the form of a reference table or a functional equation for the computing device to determine the fluid concentration based on the light transmittance and temperature of the fluid fed back by the concentration detector and the temperature sensing unit.

4. The transmission concentration device capable of reducing environmental temperature effect according to claim 1, wherein the part of the fluid circulating apparatus corresponding to the light beam emitted by the light source device and another part of the fluid circulating apparatus where the light sensor receives the light beam are light transmittable, while the other parts of the fluid circulating apparatus are non-light transmittable.

5. The transmission concentration device capable of reducing environmental temperature effect according to claim 1, wherein the light source output by the light source device is infrared light, visible light or single-wavelength light.

6. The transmission concentration device capable of reducing environmental temperature effect according to claim 1, wherein the light sensor is a photosensitive element.

7. The transmission concentration device capable of reducing environmental temperature effect according to claim 1, wherein the concentration device has a reflective element thereon capable of refracting the incidental light beam emitted by the light source device to the light sensing device.

8. The transmission concentration device capable of reducing environmental temperature effect according to claim 1, wherein the fluid communication space contains a flow channel for transporting the fluid or a fluid tank for storing fluid.

9. A transmission concentration device capable of reducing environmental temperature effect used primarily for detecting the concentration of fluid in a fluid circulating apparatus, comprising:
a light source device being a semiconductor light emitting element, the light source device outputting an optical signal and an electrical signal of voltage drop when operating under a constant voltage, the electrical signal of voltage drop corresponding to the temperature at where the light source device is located;
a light-sensing device comprising at least a light sensor, the light sensor receiving the optical signal from the light source device and outputting an electrical signal corresponding to the intensity of the optical signal; and
a computing device;
wherein the light sensor of the light sensing device and the light source device are arranged oppositely at two sides of a partial space of the fluid circulating apparatus, the optical signal output by the light source device passes through the fluid in the fluid circulating device and is projected on the light sensor of light sensing device; when a DC power of specific voltage is provided for the light source device, the optical signal intensity output by the light source device would correspond to said voltage, the light sensor of the lights sensing device outputs an electrical signal corresponding to said optical signal and the fluid concentration to the computing device; the computing device comprising a concentration-current-temperature relationship determination means to compute the fluid concentration in the fluid communication space of the fluid circulating apparatus based on the electrical signal output by the light sensor of light sending device and the electrical signal of voltage drop output by the light source device.

10. The transmission concentration device capable of reducing environmental temperature effect according to claim 9, wherein the light sensor outputs a current value, the current value corresponding to the transmittance of light beam produced by the light source device and passing through the fluid in a partial space of the fluid circulating apparatus.

11. The transmission concentration device capable of reducing environmental temperature effect according to claim 10, wherein the concentration-current-temperature relationship is embedded in the computing device in the form of a reference table or a functional equation for the computing device to determine the fluid concentration based on the light transmittance and temperature of the fluid fed back by the concentration detector and the temperature sensing unit.

12. The transmission concentration device capable of reducing environmental temperature effect according to claim 9, wherein the part of the fluid circulating apparatus corresponding to the light beam emitted by the light source device and another part of the fluid circulating apparatus where the light sensor receives the light beam are light transmittable, while the other parts of the fluid circulating apparatus are non-light transmittable.

13. The transmission concentration device capable of reducing environmental temperature effect according to claim 9, wherein the light source output by the light source device is infrared light, visible light or single-wavelength light.

14. The transmission concentration device capable of reducing environmental temperature effect according to claim 9, wherein the light sensor is a photosensitive element.

15. The transmission concentration device capable of reducing environmental temperature effect according to claim 9, wherein the concentration device has a reflective element thereon capable of refracting the incidental light beam emitted by the light source device to the light sensing device.

16. The transmission concentration device capable of reducing environmental temperature effect according to claim 9, wherein the fluid communication space contains a flow channel for transporting the fluid or a fluid tank for storing fluid.
